(19) United States
(12) Patent Application Publication
(10) Pub. No.: US 2003/0233260 A1
(43) Pub. Date: Dec. 18, 2003

(54) Computerized system and method of performing insurability analysis

(75) Inventors: David L. Snell, Alton, IL (US); Susan L. Wehrman, Ballwin, MO (US)

Correspondence Address: SENNIGER POWERS LEAVITT AND ROEDEL, ONE METROPOLITAN SQUARE, 16TH FLOOR, ST LOUIS, MO, 63102, US

(73) Assignee: Reinsurance Group of America Corporation

(21) Appl. No.: 10/171,874

(22) Filed: Jun. 14, 2002

(51) Int. Cl. G06F 17/60

(52) U.S. Cl. 705/4

(57) ABSTRACT

A method and system for evaluating insurability of an applicant for insurance from a carrier. A server, receiving and responsive to communications from a client computer, renders a contemporaneous insurability decision. The communications from the client computer include responses to an interactive questionnaire presented via a browser. A database associated with the server stores a comprehensive set of questions for collecting underwriting information and the server executes processing rules to determine which questions to present in the questionnaire. The questionnaire includes base questions and detail questions. The detail questions are each related to at least one of the base questions for collecting further information related to the respective base question. The server renders the insurability decision and exports a summary file to the carrier. The summary file includes the questions and responses thereto as well as the insurability decision.

### BACKGROUND OF THE INVENTION

The invention relates generally to insurance underwriting and, particularly, to a computerized system that gathers underwriting information, evaluates risk, and produces a point-of-sale decision on an applicant's insurability.

In the U.S., the average life insurance application takes about six weeks from application date to receipt of all delivery requirements. Unfortunately for life insurance companies, each day that the applicant waits for a response from the carrier decreases the likelihood that he or she will accept the policy. The distribution and ongoing servicing of all financial service products is changing radically. This includes life insurance. Prior methods of performing all of the steps necessary to get a life insurance contract between the customer and the insurance carrier are too slow, too expensive, and too limited in choices to the customer. Many new companies and new entrants are converging rapidly to improve dramatically every step that is involved. Therefore, any reduction in application processing time is desirable.

Presently available underwriting systems attempt to allow life insurance underwriters to define and create their own underwriting rules and decision processes for point-of-sale underwriting. Those skilled in the art are familiar with the use of interactive questionnaires for assessing risk in insurance cases. Typically, automated underwriting systems ask for personal details needed to make underwriting decisions. A risk assessment interview begins with questions designed to prompt the applicant to disclose pertinent conditions. These questions are the same as the questions printed on a traditional insurance application form (e.g., “Have you ever suffered from disorder of the stomach, bowel, or any digestive disorder?”). Depending on the answers to the beginning questions, known automated systems prompt the disclosure of further information about various conditions. Often, each condition disclosed by an applicant will have a set of drill down questions associated with it. The drill down questions are designed to gather further specific details in a controlled form. The applicant's characteristics and his or her answers to previous questions determine the order in which questions are asked in the assessment. For each applicant, questioning continues until an underwriting decision can be made. Conventional underwriting, including automated underwriting using such an interactive risk assessment questionnaire, yields an underwriting decision (i.e., accept, decline, etc.) for various conditions based on detailed information about each disclosed condition. It is also known to refer complex cases to manual underwriting.

A well known numerical rating method of underwriting attributed to Arthur Hunter and Oscar Rogers provides a numerical assessment or rating of the insurance risk presented by a particular applicant. The rating method of Hunter and Rogers assigns “credits” (e.g., negative values) to favorable factors and “debits” (e.g., positive values) to unfavorable factors based on the applicant's answers to an insurance application questionnaire. The amount of the credits and debits vary according to an assessed level of risk associated with the particular factor. The factors considered to be relevant to insurability typically relate to past and current medical conditions, age, height, weight, as well as nonmedical or lay factors. According to this well known rating system, the total rating, after accumulating the applicant's debits and credits, determines whether or not the insurance provider should accept or deny the applicant and, if accepted, the premium level required. (See The Life Office Management Association, Life Company Operations, pp. 360-61 (1982)). Over the years, the numerical rating method has been refined by numerous underwriters as new information becomes available concerning the various risk factors and to suit the particular needs of the insurance providers.

Known underwriting systems examine an applicant's various conditions as independent events and render their underwriting decisions based on a particular condition. Other known underwriting systems make cumulative underwriting decisions based on all conditions.

DeTore et al., U.S. Pat. No. 4,975,840 (the '840 patent) discloses information processing apparatus and methods for evaluating the insurability of a potentially insurable risk. The '840 patent describes an initial underwriting stage followed by a complex underwriting stage. During initial underwriting, DeTore et al. identify problems in an application database and match each problem to a corresponding impairment in an underwriting knowledge base. In addition, a particular impairment may have a programmed knowledge base or expert module associated with the impairment. DeTore et al. complete the underwriting process by (1) using an expert module, when available, to underwrite the impairment; (2) using a textual description of the underwriting process in the knowledge base to underwrite an impairment for which an expert module does not exist; and (3) allowing the underwriter the option to underwrite an impairment for which neither an expert module nor a textual description of the underwriting process exists. Elements of information relating to a particular risk (such as information taken from an insurance application form) are stored in the first database. DeTore et al. evaluate the stored information and identify additional elements of information (e.g., medical examinations, test reports, financial statements, and public records) needed to assess the risk. These elements of information from the first database are correlated with corresponding elements of information previously stored in the second database.

In the '840 patent, DeTore et al. assign weights to the elements of information in the first database either by software or by an underwriter or other system user. The weights must be assigned to at least one of the selected elements of information from the first database on the basis of predetermined relationships existing between the elements of information in the first database and corresponding elements of information in the second database. In the initial underwriting stage, software assigns weights on the basis of predetermined relationships stored in the program. DeTore et al. also require monitoring an input device for entry of the assigned weight.

Presently available expert systems for underwriting, including the systems described above, suffer from an over reliance upon a tree stricture type of analysis, and the lack of a holistic perspective. The tree approach (i.e., if the answer is A, go down this path, or if the answer is B go down this other path) becomes unwieldy as the tiers of branches increase.

Looking at these systems from an input standpoint, one must either aggravate the person entering the information by asking a multitude of very specific but tedious questions, or else risk the calamity of branching incorrectly at some point and following the wrong path to a meaningless conclusion. The prior art software used for automated underwriting asks too many questions, leading underwriters to complain that it actually takes longer to enter all of the data than it would have taken for an underwriter to manually make the decision.

The maintenance perspective of existing systems is also problematic. If a rule is changed early in the tree structure, it would likely result in the need for cascading changes throughout the rest of the tree. Even worse, other trees could be using similar questions and, thus, those questions and answers and links would need to be found and updated as well.

Another shortfall of conventional expert underwriting systems is the clumsy handling of synergies. Consider the process of underwriting a diabetic: If that person also has hypertension, then the debits associated with the combination are going to be higher than the arithmetic sum for diabetes plus hypertension. Conversely, for a skydiver who also explores caves, the arithmetic sum associated with these hazards is likely too high since the applicant cannot normally participate in both activities at one time. Prior art systems require that several questions be asked to correctly handle synergies—sometimes even repeating the same question just because it occurred in more than one tree being traversed.

In light of the foregoing, a convenient, web-enabled system that allows non-underwriting as well as underwriting professionals to gather underwriting information is desired. Such an improved system should be able to produce a decision at the point of sale on whether the applicant is accepted, denied or referred to a human underwriter. Moreover, such a system that can be customized for each carrier that uses it is needed. The carrier should be able to gather custom detailed information as well as select from default questions or create its own questionnaire. The system should also have the ability to track the questions asked of a particular applicant and the applicant's answers.

### SUMMARY OF INVENTION

The invention meets the above needs and overcomes the deficiencies of the prior art by providing improved underwriting with a convenient, web-enabled system. According to one aspect of the invention, a robust and intuitive computerized underwriting system quickly and efficiently handles multiple online insurance applications, including managing input errors by applicants. The present invention is also flexible to permit customization for several different modes of selling and for foreign markets and to permit non-underwriting as well as underwriting professionals to gather information from applicants. Advantageously, such an improved system is able to produce a decision at the point of sale on whether the applicant is accepted, denied or referred to a human underwriter. Within these broad categories, the acceptance may be at one of various premium levels; the decline may be until a certain time period has elapsed (for reconsideration); and the referral to a human underwriter may ask for additional, free-form, information from the applicant, or trigger queries to third party sources for more information. Further aspects of the invention permit fast and easy changes across several client platforms and maintain the privacy of applicant information and the confidentiality of the underwriter's proprietary set of rules. Moreover, the features of the present invention described herein are less laborious and easier to implement than currently available techniques as well as being economically feasible and commercially practical.

Briefly described, a computerized method of evaluating insurability of an applicant for insurance from a carrier includes defining processing rules. The processing rules determine which questions in a comprehensive set of application questions are to be presented to the applicant for collecting underwriting information from the applicant and determine an order of presentation of the questions. The processing rules are based on underwriting rules associated with the carrier for rendering a decision on the insurability of the applicant from the underwriting information collected from the applicant. The method also includes presenting an interactive questionnaire via a browser operating on a client computer, receiving responses to the questions, and rendering a contemporaneous decision on the insurability of the applicant based on the questionnaire and the responses thereto from the applicant. In this embodiment, the questionnaire includes one or more base questions and one or more detail questions selected from the comprehensive set of questions according to the processing rules. The detail questions are each related to at least one of the base questions for collecting further information related to the respective base question.

A computerized system embodying aspects of the invention includes a data communication network and a server, receiving and responsive to communications from a client computer, for rendering a contemporaneous decision on the insurability of an applicant. The server and client computer are both coupled to the data communication network and the communications from the client computer include responses to an interactive questionnaire presented via a browser operating on the client computer. The system also includes a database associated with the server. The database stores a comprehensive set of questions for collecting underwriting information from the applicant. In this embodiment, the questionnaire includes one or more base questions and one or more detail questions selected from the comprehensive set of questions according to processing rules executed by the server. The detail questions are each related to at least one of the base questions for collecting further information related to the respective base question. The server renders the insurability decision on the applicant based on the questionnaire and the responses thereto from the applicant. The system further includes a first interface for exporting a summary file to the carrier. The summary file includes the questions presented in the questionnaire and the responses thereto and includes the insurability decision on the applicant.

Alternatively, the invention may comprise various other methods and apparatuses.

Other objects and features will be in part apparent and in part pointed out hereinafter.

### BRIEF DESCRIPTION OF THE DRAWINGS

FIG. 1 is a block diagram of a computerized underwriting system according to one embodiment of the invention.

FIG. 2 is an exemplary screen shot from an interactive questionnaire for collecting underwriting information.

FIG. 3 is a block diagram of the system of FIG. 1 as implemented by a markup language application.

FIG. 4 is a block diagram illustrating the logical architecture of the system of FIGS. 1 and 3.

FIG. 5 is a block diagram illustrating the physical architecture of the system of FIGS. 1 and 3.

Corresponding reference characters indicate corresponding parts throughout the drawings.

### DETAILED DESCRIPTION OF THE INVENTION

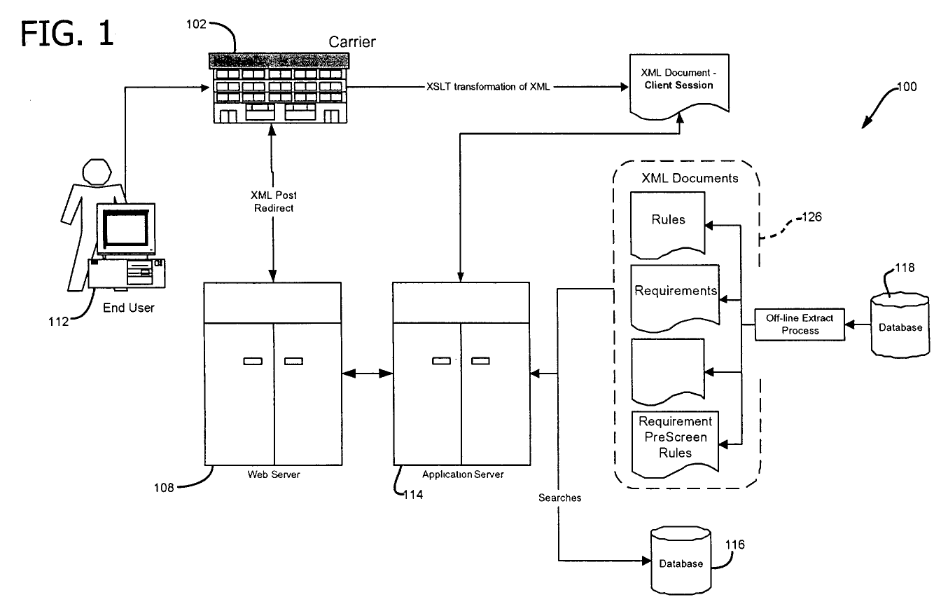

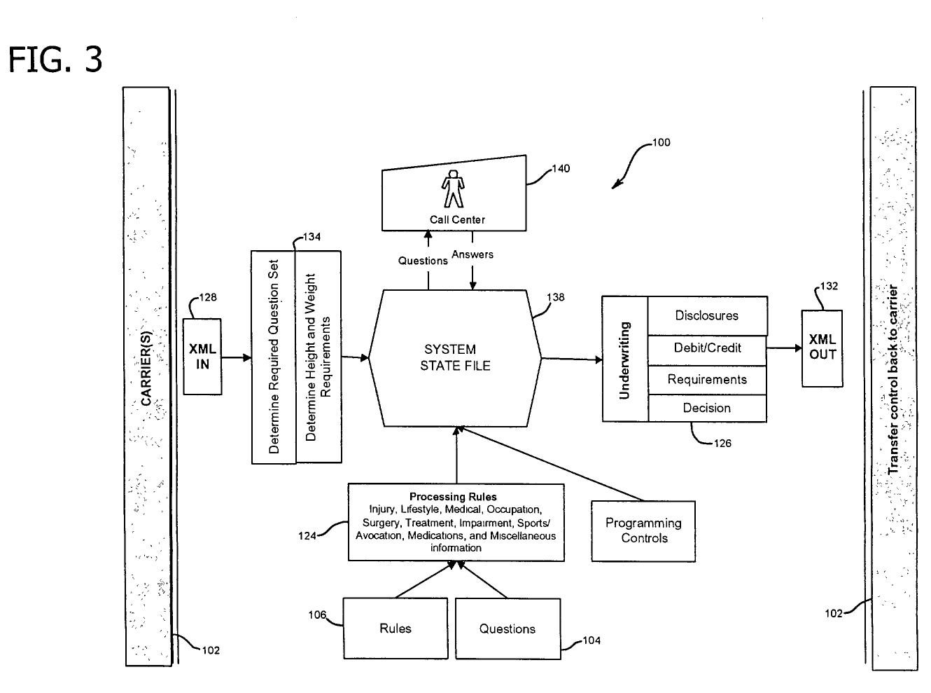

Referring now to the drawings, FIG. 1 illustrates a computerized underwriting system 100 embodying aspects of the invention. The system 100 is a web-enabled application that allows an insurance provider, or carrier 102, to gather underwriting information for producing a point-of-sale decision on an applicant's insurability. Advantageously, the information need not be gathered by a professional underwriter. System 100 integrates a risk assessment questionnaire 104 (see FIG. 3) with underwriting rules 106 (see FIG. 3) to create an interactive questionnaire for assessing risk in insurance cases. The questions are generally of the type printed on a traditional insurance application form (e.g., “Have you been treated for or diagnosed as having respiratory disorder including asthma and emphysema?”). Depending on the answers to the beginning questions, system 100 prompts the applicant to disclose further information about various conditions. Typically, each condition disclosed by the applicant will have a set of drill down or detail questions associated with it. The drill down questions are designed to gather further specific details in a controlled form. System 100 presents questions to the applicant one at a time and the applicant's answer determines which question will be asked next in the sequence. In one embodiment of the invention, system 100 provides graphical interfaces for presenting questions in the form of two side-by-side frames. One frame contains base questions along with yes/no check boxes and the other frame contains detail questions relating to the condition disclosed by the particular base question.

The applicant's characteristics and his or her answers to previous questions determine which questions will be asked later in the assessment. For example, if the applicant discloses a particular condition, several reflexive drill down questions may apply to seek additional information. However, the applicant's answer to the first drill down question may resolve all of the subsequent questions, allowing them to be skipped. In this manner, system 100 presents the applicant only with questions from a comprehensive set of application questions that are related to the conditions he or she has disclosed. The carrier 102 can select the set of questions 104 for the applicant from default questions in the system or it can request its own set of questions. The depth and breadth of underwriting can be varied according to the sales need or other considerations. For example, a rule set can be as simple as a relatively small number of base questions or have many levels of nesting to provide the level of granularity desired by the underwriter. Moreover, it is contemplated that a detail question could serve as a base question for other detail questions.

In one embodiment of the present invention, system 100 is customizable for different carriers, jurisdictions, and so forth. For example, system 100 differentiates the small number of base level questions by scenario (a set based primarily upon location) and has multiple scenarios that utilize a single set of rule trees for multiple locations with minimal redundancy of data. In the case of life insurance sales in the United States, differences in the insurance laws from one state to another may lead carrier 102 to use many different applications, each with different language, for a single insurance product. Similarly, the different products offered by carrier 102 will likely have different underwriting rules or different debits applied to various impairments. Conventional rules database systems must maintain several copies of their rules, which increases both storage and maintenance requirements.

In the illustrated embodiment of FIG. 1, a web server 108 handles the presentation of system 100 and provides an interface to the other layers of the system. The web server 108 executes routines to generate hypertext markup language (HTML) documents for a client browser of an end user 110. Although not limited to such browsers, two examples of suitable browsers for use in connection with the present invention are those shipped with Microsoft® Internet Explorer and Netscape Navigator®. In this instance, the end user 110 is situated at a call center operated by carrier 102 or even in the applicant's home or office. It is to be understood that system 100 can be implemented either as a stand-alone web site or can co-exist as a frame within the existing web site of carrier 102.

Further, an application server 112 executes business logic and data management tasks for system 100. As will be described below, the application server 112 manages a database 116, which stores, for example, one or more user specific state files 114 (see FIG. 3) containing information from the insurance application. Although the database 116 is shown separately from application server 112, it is to be understood that in other embodiments of the invention, database 116 may be contained within server 112. Database 116 preferably has a built-in audit tracking feature, which allows system 100 to perform historical tracking and to regenerate questions asked an applicant for a past date and time. This can save untold hours of reconstruction necessary with other systems, particularly for large sets of applicants (e.g., a class action lawsuit). In addition, such a feature provides a reporting facility for historical tracking, ad-hoc queries, and other management information. Historical tracking provides the means to view what rules were in place at a given date.

In operation, system 100 executes a set of processing rules 124 (see FIG. 3) to render a decision based on the information gathered from the applicant through these questions. System 100 automatically decides whether to accept, decline, or postpone coverage, apply premium loadings, or request medical reports. The system 100 refers complex cases for manual underwriting. Following the risk assessment phase, system 100 reports the underwriting decision to the applicant.

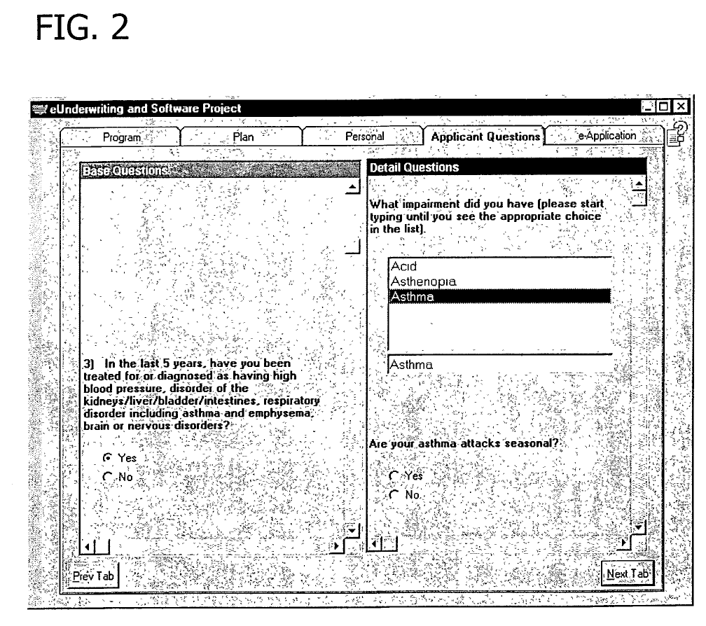

FIG. 2 is an exemplary screen shot of a base application question presented to the applicant side-by-side with one or more associated detail questions. With respect to browser presentation, system 100 presents a tabbed dialog user interface for navigating user 110. Once all of the information on a tab is complete, system 100 permits next tab to be viewed. For example, FIG. 2 shows a “Program” tab for displaying information about carrier 102 and a “Plan” tab for gathering premium-related information such as term length and payment. A tab labeled “Personal” contains specific applicant information and an “Applicant Questions” tab is used for presenting the risk analysis questionnaire to the applicant. An “eApplication” tab informs the applicant of the final decision. A “Special Questionnaire” tab, not shown, contains “Refer to Underwriter” questions plus the question\statement that gave rise to the referral action. If a rule results in a “Refer to Underwriter” or if an applicant cannot locate his or her particular impairment in a pull-down list, then system 100 presents a special questionnaire. For example, the applicant is prompted to provide, among other things, the name of the condition, when it was first diagnosed, and a description of the symptoms.

With respect to “Applicant Questions”, the user interface of system 100 displays questions in, for example, a single page “tree like” approach to allow base level and detail questions to be hierarchically organized. When in a single branch view mode, system 100 hides all base questions from view while detail questions are being answered. This allows the applicant (or user conducting an interview) to focus on the detail questions, minimizing the possibility of the applicant not completing all of the detail questions before returning to the more general base application questions. Users may hide/show detailed questions under a base question by clicking a button to toggle the visible state. In this embodiment, only completed question branches may be hidden. The user interface provides additional buttons to expand and collapse all detail question branches. After each question is answered, the user interface advances focus via auto-scrolling to the next unanswered question of the application, where possible. System 100 also provides the option to automatically re-position the questionnaire so that the next unanswered question is displayed at the top of the screen.

This tab presents the questions used to determine if the applicant is accepted, denied, or if the decision should be postponed for a period of time or referred to an underwriter for a life insurance policy. This decision is based, of course, upon the applicant's answers to the base and detail questions. Some questions have associated debits, credits, or immediate denials or postponements associated therewith. System 100 tracks the points for rendering a point of sale determination. Once the applicant has completed the questionnaire, system 100 calculates a debit total and awards a policy if the debit total is within a certain tolerance range. For example, a condition such as diabetes could count as 75 debits as a base rate and adjust upward or downward depending upon treatment or complications. This debit total might increase another 75 debits if the applicant is Insulin dependent, and another 100 debits if onset was diagnosed while a teenager. A slight level of hypertension as a cofactor here could add another 50 debits.

The system may be configured to always ask a specified set of questions or to stop asking questions as soon as a decision is apparent from the internally running debit count. The former is desirable for carriers who wish to have a record of treating all applicants similarly in the questioning process. The latter approach minimizes the time and expense associated with a call center person asking the questions over a telephone.

In the present example, the left frame presents a base question such as whether the applicant has a respiratory disorder. If the applicant answers “yes” to the respiratory disorder question, then the right frame presents a follow-up question to identify the particular disorder (e.g., asthma). System 100 takes the approach that a human underwriter or a life insurance agent would (e.g., by asking more directly, “what did you have?”) and then compares the applicant's answer against a comprehensive list of conditions to narrow in on the best match. Preferably, system 100 executes a routine to assist the applicant by phonetically matching the letters typed into a text box with known words, such as the names of various impairment or medications. Advantageously, the applicant need not know the correct spelling for the word. Moreover, the present invention takes language and dialect variations into account when implementing the phonetic search feature. In particular, system 100 provides a base set of American English consonants and modifies these categorizations for other languages as necessary. The phonetic search feature is preferably in addition to storing common misspellings in a database.

If the answer to the detailed question leads to another question, such as whether the applicant's asthma is seasonal, system 100 presents it below the first detailed question. System 100 also indicates when all of the branching questions for the particular base question have been answered and returns the applicant's attention to the left frame for the next base question. Questioning continues in this manner until an underwriting decision can be made. For example, debits are totaled from all of the answers as well as height, weight, age, and/or coverage data passed from carrier 102.

Within the broad categories of decisions, the acceptance may be at one of various premium levels; the denial may be until a certain time period has elapsed (for reconsideration); and the referral to a human underwriter may ask for additional, free-form, information from the applicant, or trigger queries to third party sources for more information.

As described above, system 100 integrates a risk assessment questionnaire 104 with underwriting rules 106 to create an interactive questionnaire for assessing risk in insurance cases. In operation, system 100 executes the processing rules 124 to render a decision at 126 whether to accept or deny the applicant, postpone the decision, or refer the case to an underwriter based on the information gathered from the applicant through these questions.

The system 100 also contemplates the use of wrap-up questions to confirm whether additional information needs to be disclosed. The questionnaire administrator has the option on setup to have one wrap-up question for an entire branch, or to have individual wrap-up questions for the ends of multiple branching parts. The wrap-up question loop repeats until the applicant selects an answer that signals there is no further information to disclose. Although there is a distinction in presentation, base questions and detail questions (reflexive, standard, or nonstandard) have the same rule processing. Each type of rule can have engine variables, question variables and wrap-up questions.

The system 100 uses engine variables is to match-up previously obtained information to base questions to avoid the need for the user 110 to answer the question a second time or to preset values in advance for guiding the question process. Engine variables are parameters determined from personal data information (e.g., date of birth, systolic blood pressure) input by the user 110 directly or passed from an administration system. Engine variables can also be inferred from existing information. As an example, if height and weight are known, then an overweight condition can be determined).

In one embodiment of the invention, system 100 defines an External Engine Variable (ExtEV) that is passed from carrier 102 and, thus, is considered “external” to system 100. If a question has an engine variable attached to it and any of the question's answers match any of the ExtEVs, system 100 displays the question in an unchangeable state. Questions that have been answered by an ExtEV can also be set to be silent. A silent question is one that is not explicitly asked if the answer can be inferred from engine variables. System 100 infers certain conditions, such as obesity, based on engine variables rather directly asking the applicant whether he or she is obese. In silent mode, system 100 stores the answers in the session file 114 but optionally displays the question to the screen (controlled by a system setting) and automatically directs the user 110 to the next question. It may be necessary to select a default answer when using the silent question functionality.

As an example, when question wording varies by location, the rules administrator sets up a silent question and passes the engine variable of where the applicant resides: “Where do you reside? London; Africa; United States; or #Other.” If the ExtEV does not match any of the question's answers, a check is made for an Engine Variable Default (EVD) answer, identified in this instance by prefixing the answer text with a “#” symbol. When system 100 selects the EVD as the question's answer, the question is displayed in an unchangeable state. System 100 uses the “#” prefix to identify an answer as an EVD so it may removes the prefix from the answer text before display. If there is an ExtEV for a question that does not match any of the question's answers and if there is not an EVD defined for the question, then system 100 displays the question in a normal, changeable state.

The system 100 further defines an Internal Engine Variable (IntEV). When a question has an engine variable assigned to it but carrier 102 did not provide a matching ExtEV and there is no pre-defined EVD, then system 100 stores the user's answer as an IntEV. In this embodiment, system 100 uses the IntEV to pre-answer any other questions on the application that have the same engine variable associated therewith. The other questions on the application then behave in the same way as if they had an ExtEV prepopulating their answers, i.e. they become unchangeable. If the original question that created the IntEV is changed, system 100 propagates the change to the other questions that have the same engine variable attached to them.

Referring again to FIG. 1, system 100 includes a relational database 118 containing all of the underwriting questions, impairments, medications, products, company information, and the like. In general, the database 118 stores the data that is needed to drive the application. One strength of the present invention lies in its ability to have subsets. System 100 permits carrier 102 to have one major set of thousands of rules and answers, yet vary those rules slightly by product, or locale (or language or sales campaign or company) and not have to maintain multiple copies of the larger, base set.

Although database 116 and database 118 are illustrated separately, it is to be understood that the two can be combined in a single database structure containing not only the application data but also the answers and associated questions for the applicant. Preferably, system 100 employs an input facility, such as one created in the Visual Basic® development system from Microsoft Corporation, to allow database 118 to be easily updated and modified. An Oracle® 8i database available from Oracle Corporation, for example, is suitable for use as database 118.

FIG. 3 illustrates further aspects of system 100. In this embodiment, system 100 is implemented by a markup language application. In other words, all of the internal session files (e.g., file 114) and even the client rules files are in a markup language such as extensible markup language (XML). This provides ease of implementation and interoperability between other applications. As shown in FIG. 3, system 100 receives initial application information, premium information, and the like from carrier 102 via an XML feed at 128. System 100 also receives data from a carrier's (or distributor's) system to pre-populate (or even skip) the personal data screens prior to the actual underwriting process. In one embodiment, system 100 may be customized for each carrier 102 to permit gathering custom detailed information.

Preferably, carrier 102 passes one or more question filters to system 100 via the XML feed at 128 to focus the questions on, for example, specific products offered by carrier 102. By filtering the questions, system 100 selects the proper questions to be displayed during the session. In other words, only the questions that match the passed filters are displayed to the user 110. When the question filter is not passed, all questions for a set/subset code are displayed. If no filters are passed from carrier 102, system 100 displays all of the questions regardless of the filter. On the other hand, if carrier 102 passes filters, system 100 checks each question against the filter before displaying it in the application. APPENDIX A sets forth an example of input XML, including question filters.

The system 100 accepts XML feeds of base information (e.g., name, address, height, etc.) to eliminate the need for re-keying. Likewise, system 100 interfaces with or feeds the administrative system of carrier 102 with an XML summary of all the data collected during the application process and the underwriting decision at 132. When the application is complete, the decisions that have been set by answering questions and by passing height, weight, age, and/or coverage values are reviewed and a compiled decision is passed back to carrier 102. The use of XML permits interfacing with system 100 to be accomplished as simply as possible.

The system 100 preferably uses bulk data import/export facility to massively process many applicants through the system. Taking the XML file 132 created during the applicant process and importing the information into database 116 implements bulk data import. The export facility is achieved by creating an XML file 132 with only the specific applicant information and then sending the XML file 132 to the desired location.

As will be described in detail below, system 100 determines at 134 which question set should be used for the particular carrier 102 and the carrier's particular height and weight requirements for validation of the application.

A state file 114 in the embodiment of FIG. 3 provides a central repository for all information in the application. For example, the state file 114 is an XML representation of any questions answered, including the user's responses to questions as well as decisions, requirements/actions, debits/credits, passed in information, and information to uniquely identify the user's session for restarting purposes.

FIG. 3 further illustrates a call center 140. As described above, system 100 provides a risk assessment interview with a set of questions designed to prompt the applicant to disclose pertinent conditions. The potential applications include call centers such as call center 140, kiosks, bank representatives, Internet users, worksite marketing representatives, and so forth. In the call center embodiment, one or more users 110 staff the call center 140 for conducting interviews with applicants. The staff of call center 140 ask the series of base and related detail questions as appropriate, and enter the applicant responses. In the alternative, the applicant could work through the questions and answers directly.

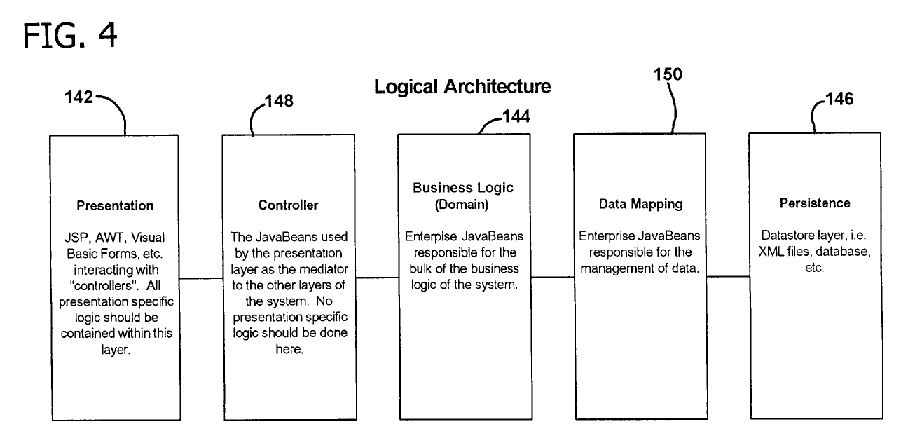

Referring now to FIG. 4, system 100 is a multi-tier system, which takes three primary architecture layers of presentation 142, business logic 144, and data source 146 and adds two layers. These additional layers are inserted between the presentation 142 and data source 146 layers to further decouple the business logic 144 from the presentation 142 and data source 146 requirements. The resulting five logical layers are presentation 142, controller 148, domain 144, data mapping 150, and persistence 146.

The presentation 142 layer preferably includes all of the objects required for displaying output and taking input from user 110 for the presentation format chosen. In other words, all presentation specific logic is contained within this layer. For example, presentation 142 consists of JavaServer Pages (JSP) that will be generating the hypertext markup language (HTML) documents for the client browser. In the alternative, this layer is a Visual Basic application, Java Applet, or Java Application using, for example, Abstract Window Toolkit or Swing.

In FIG. 4, the controller 148 layer is responsible for mediating calls from the presentation 142 layer to the domain 144 (business logic) layer. For example, controller 148 includes the application components (e.g., JavaBeans) used by presentation 142 as the mediator to the other layers of system 100. Display logic that is independent from the medium is kept here to prevent unnecessary repetitive calls to domain 144 because they are expensive to make. The presentation 142 and controller 148 layers normally reside on the same physical machine embodying a web container.

The domain 144 layer, i.e., the primary business logic for system 100, is where the commonly known “middle tier” resides. In one embodiment, an application programming interface, such as Enterprise JavaBeans (EJB), running on a EJB capable application server is responsible for the bulk of the business logic. Both stateful and stateless session EJBs exist on this middle tier depending on their particular usage.

The data mapping 150 layer of FIG. 4 holds objects for storing and retrieving the data necessary for operation of system 100 (e.g., information necessary to produce the questions, answers, and decisions (rules, answers, conditions, requirements, etc.)). Data mapping 150 also stores user specific state files (e.g., state file 114) containing all the information about what the applicant has completed on the application. These objects are preferably implemented by session EJBs, both stateful and stateless, responsible for the management of data. The data mapping 150 layer does not, however, contain the details as to exactly how the data is stored on the particular media being used (XML files, database, etc), the responsibility for which lies in the final layer.

The fifth and final layer is the persistence 146 layer. Persistence 146, also referred to as a datastore layer, handles the details of storing and retrieving the data from the particular medium selected (XML files, database, etc.). These objects are implemented in this embodiment as standard Java objects and reside on the same physical tier as the datamapping 150 layer. Depending on the media used, the goal is to allow for these objects to be swapped out as needed.

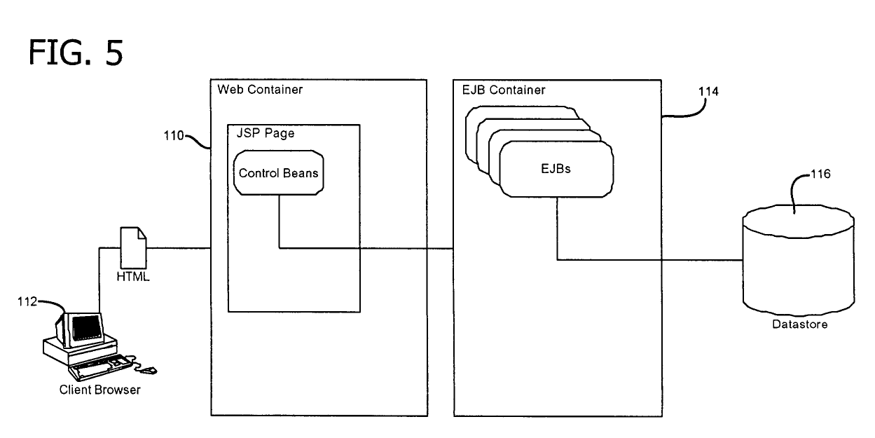

Referring now to FIG. 5, the physical architecture of system 100 may have many configurations depending on, for example, the size of the application questionnaire and the number of expected concurrent users 110. Simple configurations are contemplated as a starting point, with expansion across multiple servers as the loads continue to grow and the need to scale increases. With respect to mapping the logical layers to a physical architecture, the presentation 142 and controller 148 layers preferably reside on the web server 108 and run inside a web container (this could be in a single server or replicated across multiple servers as in a server farm). As described above, the JSPs of presentation 142 generate HTML documents for the client browser of user 110. Further, the domain 144 and data mapping 150 layers preferably exist as EJBs running inside an EJB container of the application server 112. These two layers may all run on a single application server or, if scalability becomes an issue, be distributed vertically across multiple servers, replicated horizontally as a server farm or both. The EJB container manages a datastore 116 of, for example, user specific state files (e.g., state file 114) containing all the information about what the applicant has completed on the application. FIG. 4 shows how the web container and the EJB container relate in system 100.

Referring again to FIG. 1, a sample computerized underwriting session begins when user 110 on the web site of carrier 102 navigates to a point where an underwriting session is desired for further questioning. Carrier 102 collects the data it has and packages it in an XML Request Transaction. Carrier 102 then posts the request to web server 108. A component tier of the system logic starts the session and tests the Request Transaction for completeness. As described above at 134, web server 108 tests height/weight/coverage parameters if they are provided and required. If the Request Transaction is within acceptable parameters and complete, the actual questioning session begins.

The system 100 creates a unique session identifier to specifically identify each application and uses the session ID to create the state file 114 containing, among other things, a list of all questions and related answers. The session ID may be used at a later time to finish an incomplete questionnaire, determine the final decision of a completed questionnaire, or accomplish other questionnaire tasks. In the embodiment of FIG. 1, the calling application creates a unique identification for each application. The session ID may be, for example, up to 40 characters in length and contain letters or numbers only (e.g., a globally unique identifier (GUID) created using the Windows® function COCreateGUID). Once the applicant has fully completed all sections of the application, the responses, impairments, debits, requirements associated with the responses, and the rule-based decision are packaged in an XML Response Transaction and sent back to a response handling page at the web site of carrier 102. Preferably, each question has the ability to hold custom codes in the form of alias tags that can be used by the client to interface with outside components, such as completing print applications or automating the ordering process of paramedical exams.

On the other hand, if system 100 is configured to decline an applicant based on the height/weight/coverage parameters and the Request Transaction data is not within acceptable ranges, or if the Request Transaction is incomplete, system 100 packages an XML Response Transaction and sends it back to the response handling page at the web site of carrier 102.

The export process, described above at 132, involves taking the XML state file and transforming the XML information to meet client specifications. Once a session is complete, system 100 automatically returns the information to a uniform resource locator (URL) supplied in the input parameters via an HTML form post. In the present embodiment, the URL is absolute and references a specific page residing on the web site of carrier 102. For example, system 100 sends all questions and responses gathered during the session back to the calling application. System 100 preferably formats the information as a complete XML document and contains it in a hidden form field named, for example, “XMLQuestions.” This XML document, shown at 126 in FIG. 3, has several sections including questions and answers; debits; underwriting decision; height/weight/coverage requirement/action information. Each carrier 102 can export a customized XML document to the client by applying a style sheet to reformat the document. For example, an extensible stylesheet language transform (XSLT) can be used to generate the desired XML format requested by the client. APPENDIX B sets forth an example of exported XML.

Referring further to validation at 134 (see FIG. 3), system 100 provides validation based on a combination of the applicant's gender, age, height, and/or weight. For example, if the applicant's weight for the specific gender, age, and height is outside an acceptable weight range, system 100 performs a combination of adding debits, adding underwriting requirements/actions, rendering an underwriting decision, and/or increasing premiums. System 100 preferably performs the validation before the underwriting process begins.

Advantageously, system 100 is a stateless web program, which promotes scalability. In other words, system 100 stores the entire session to a special session file 114 (e.g., XML session file unique for that applicant) on the hard drive every mouse click or text entry. Because system 100 does not store session files in a memory associated with server 112, the server's memory capacity does not limit the number of applicants that can use the system. This aspect of the invention also permits the applicant to leave the underwriting process (perhaps to check on a medical history item) and return to the same screen later with no loss of information. The most common reason for failure of expert systems is that the rules base is not sufficiently scalable due to memory limitations. Moreover, such prior art systems require the applicant to re-enter information after leaving the system.

In a preferred embodiment of the invention, system 100 pre-fetches some questions to reduce the number of server calls and to speed up the application data entry time. When loading a question into the application, a check is made to see if all the answers for the question point to the same next question. If so, system 100 pre-fetches that particular rule and makes it available to the user 110. This feature may be used to permit several unanswered questions to be displayed at the same time so that the user 110 can provide answers to multiple questions without having to submit each one individually.

The system 100 preferably uses a plurality of modes for rendering declines, or denials, to provide additional customization for carrier 102. The use of modes allows different behaviors to occur when a decline decision is reached. For example, in a default mode, system 100 continues as normal and answers may be changed in any manner. In one configuration, system 100 stops asking additional detail questions after declining the applicant, although remaining displayed questions must be completed. In this second mode, the user 110 may change answers but it will have no affect on the decline decision. In a third mode, system 100 stops asking additional detail questions after declining the applicant but remaining displayed questions must be completed. Changing answers in the third mode can reverse a decline decision. In a fourth mode, system 100 immediately conveys the decline to the user 110 and exits.

With respect to searching, many of the textual searches in system 100 are phonetically encoded. This means that the applicant need not provide the exact spelling of any item to search. System 100 searches by how the entered “word” sounds. This is particularly helpful when searching for medicines and treatments/illnesses that have complicated spellings. Advantageously, the present invention takes language and dialect variations into account when implementing the phonetic search feature. In particular, system 100 provides a base set of American English consonants and modifies these categorizations for other languages as necessary. The phonetic search feature is preferably in addition to storing common misspellings in a database.

Alias searching is also available. When conducting a search, the user 110 obtains results provided with results that have been matched up as being same or like the condition you submitted. This can include variations of the name of a sport or occupation or differences between brand-names of common drugs. Further, the search is context sensitive (e.g., if the applicant is being questioned about participation in hazardous sports, the matches are against sports such as skydiving, auto racing, etc. instead of against surgeries, medicines, or diseases).

In addition to the hidden field, “XMLQuestions,” system 100 preferably returns two other hidden form fields: “UniqueSessionID” and “DecisionCode.” UniqueSessionID returns the value passed into system 100 at 128. DecisionCode returns a value up to four characters in length denoting the automated underwriting decision. This value can be one of the following: DCL—Decline; PP*—Postpone, with a number following representing number of months before a person would be allowed to reapply; RUW—Refer to Underwriting for decision; ACC—Accept; None—No decision set, assumed Accept. APPENDIX B further illustrates sample posted form fields.

Although described in connection with an exemplary computing system environment, the invention is operational with numerous other general purpose or special purpose computing system environments or configurations. The computing system environment is not intended to suggest any limitation as to the scope of use or functionality of the invention. Moreover, the computing system environment should not be interpreted as having any dependency or requirement relating to any one or combination of components illustrated in the exemplary operating environment. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, executed by one or more computers or other devices. Generally, program modules include, but are not limited to, routines, programs, objects, components, and data structures that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

As described herein, the present invention provides a convenient, web-enabled system that allows non-underwriting as well as underwriting professionals to gather underwriting information is desired. Such an improved system is able to produce a decision at the point of sale on whether the applicant is accepted, denied or referred to a human underwriter using a holistic approach. Moreover, such a system can be customized for each carrier that uses it. The carrier can gather custom detailed information as well as select from default questions or create its own questionnaire. The system also has the ability to track the questions asked of a particular applicant and the applicant's answers.

As the number of rules increases, the maintenance burden increases at a much faster rate. The present invention minimizes this task by providing a means to “jump” from one tree to another, or even back again, via questions that accept free-form answers and compare them phonetically (using phonetic rules specific to the language and dialect desired) to lists of known ailments and conditions. Once chosen, these carry forward the questioning process on a more intelligent basis. This provides needed detail without unnecessary tedium to acquire it.

Moreover, the present invention defines attributes that follow an applicant through the underwriting process and incorporates a mechanism for combining these attributes in a non-linear manner. Thus, an applicant entering, for example, a diabetes tree of questions, but carrying an attribute of hypertension with her, will be treated accordingly, without the need to duplicate questions.

When introducing elements of the present invention or the preferred embodiment(s) thereof, the articles “a,” “an,” “the,” and “said” are intended to mean that there are one or more of the elements. The terms “comprising,” “including,” and “having” are intended to be inclusive and mean that there may be additional elements other than the listed elements.

In view of the above, it will be seen that the several objects of the invention are achieved and other advantageous results attained.

As various changes could be made in the above constructions and methods without departing from the scope of the invention, it is intended that all matter contained in the above description and shown in the accompanying drawings shall be interpreted as illustrative and not in a limiting sense.

[image]

What is claimed is:

1. A computerized method of evaluating insurability of an applicant for insurance from a carrier, said method comprising:
defining processing rules to determine which questions in a comprehensive set of application questions are to be presented to the applicant for collecting underwriting information from the applicant and to determine an order of presentation of the questions, said processing rules being based on underwriting rules associated with the carrier for rendering a decision on the insurability of the applicant from the underwriting information collected from the applicant;
presenting an interactive questionnaire via a browser operating on a client computer, said questionnaire including one or more base questions and one or more detail questions selected from the comprehensive set of questions according to the processing rules, said detail questions each being related to at least one of the base questions for collecting further information related to the respective base question;
receiving responses to the questions presented to the applicant in the questionnaire; and
rendering a contemporaneous decision on the insurability of the applicant based on the questionnaire and the responses thereto from the applicant.

2. The method of clam 1 wherein the processing rules differ from one carrier to another as a function of the underwriting rules associated therewith.

3. The method of claim 1 further comprising receiving, at a server, communications from the client computer for rendering the insurability decision on the applicant, said server and said client computer being coupled to a data communication network, said communications from the client computer including the responses to the questionnaire from the applicant.

4. The method of claim 3 further comprising storing one or more state files in a database associated with the server, said state files each containing information relating to the questionnaire and the responses thereto from the applicant.

5. The method of claim 4 wherein the state file is a markup language representation of one or more of the following: the questions presented to the applicant in the interactive questionnaire; the responses to the questionnaire from the applicant; the insurability decision on the applicant; and initial application information from the carrier.

6. The method of claim 3 further comprising importing initial application information from the carrier to the server.

7. The method of claim 6 wherein the initial application information includes one or more of the following: filters for use on the questions in the comprehensive set of questions; debits/credits associated with the questions; and a unique identifier of each application session of questions and responses.

8. The method of claim 3 further comprising exporting a summary file of each application session of questions and responses from the server to the carrier.

9. The method of claim 1 further comprising defining the comprehensive set of questions for collecting underwriting information from the applicant based on information provided by the carrier.

10. The method of claim 1 wherein presenting the interactive questionnaire comprises providing a framed user interface in which the base questions are presented in one frame and the detail questions related thereto are presented in another frame.

11. The method of claim 1 wherein presenting the interactive questionnaire comprises providing a tabbed dialog user interface for navigating a user of the client computer through each application session of questions and responses.

12. The method of claim 1 further comprising pre-fetching a plurality of the base questions having the same detail question associated therewith for processing together.

13. The method of claim 1 further comprising communicating the decision on the insurability of the applicant to the applicant via the browser of the client computer.

14. The method of claim 1 wherein the insurability decision is one of the following: acceptance at a best available rate; acceptance with a premium loading; denial; postponement of coverage; and referral to manual underwriting.

15. The method of claim 1 further comprising defining phonetic equivalents of textual responses to the questionnaire and retrieving known words based on the phonetic equivalents.

16. The method of claim 1 further comprising assigning an engine variable to one or more of the questions in the comprehensive set of application questions for use in matching underwriting information previously obtained from the applicant to minimize redundant responses from the applicant.

17. The method of claim 16 further comprising determining if an external engine variable parameter received from the carrier matches any of the available responses to the questions for which the engine variable is assigned and, if so, presetting the external engine variable parameter as the response to the questions.

18. The method of claim 17 further comprising presetting an engine variable default response as the response to the questions for which the engine variable is assigned if the external engine variable parameter does not match any of the available responses to the questions.

19. The method of claim 17 further comprising defining the response from the applicant to one of the questions for which the engine variable is assigned as an internal engine variable parameter and presetting the internal engine variable parameter as the response to the other questions for which the engine variable is assigned if the external engine variable parameter does not match any of the available responses to the questions.

20. The method of claim 1 wherein one or more computer-readable media have computer-executable instructions for performing the method of claim 1.

21. A computerized system for evaluating insurability of an applicant for insurance from a carrier, said system comprising:
a data communication network;
a server receiving and responsive to communications from a client computer for rendering a contemporaneous decision on the insurability of the applicant, said server and said client computer being coupled to the data communication network, said communications from the client computer including responses to an interactive questionnaire presented via a browser operating on the client computer;
a database associated with the server storing a comprehensive set of questions for collecting underwriting information from the applicant, said questionnaire including one or more base questions and one or more detail questions selected from the comprehensive set of questions according to processing rules executed by the server, said detail questions each being related to at least one of the base questions for collecting further information related to the respective base question, said server rendering the insurability decision on the applicant based on the questionnaire and the responses thereto from the applicant; and
a first interface for exporting a summary file to the carrier, said summary file including the questions presented in the questionnaire and the responses thereto and including the insurability decision on the applicant.

22. The system of claim 21 wherein the processing rules executed by the server determine which questions in the comprehensive set of application questions are to be presented to the applicant for collecting the underwriting information from the applicant and determine an order of presentation of the questions.

23. The system of claim 21 wherein the processing rules are based on underwriting rules associated with the carrier for rendering the insurability decision on the applicant from the underwriting information collected from the applicant.

24. The system of clam 23 wherein the processing rules differ from one carrier to another as a function of the underwriting rules associated therewith.

25. The system of claim 21 wherein the database stores one or more state files each containing information relating to the questionnaire and the responses thereto from the applicant.

26. The system of claim 25 wherein the state file is a markup language representation of one or more of the following: the questions presented to the applicant in the interactive questionnaire; the responses to the questionnaire from the applicant; the insurability decision on the applicant; and initial application information from the carrier.

27. The system of claim 21 further comprising a second interface for importing initial application information from the carrier to the server.

28. The system of claim 27 wherein the initial application information includes one or more of the following: filters for use on the questions in the comprehensive set of questions; debits/credits associated with the questions; and a unique identifier of each application session of questions and responses.

29. The system of claim 27 wherein the first and second interfaces comprise markup language postings.

30. The system of claim 21 further comprising a framed user interface in which the base questions are presented in one frame and the detail questions related thereto are presented in another frame.

31. The system of claim 21 further comprising a tabbed dialog user interface for navigating a user of the client computer through the interactive questionnaire.

32. The system of claim 21 wherein the insurability decision is one of the following: acceptance at a best available rate; acceptance with a premium loading; denial; postponement of coverage; and referral to manual underwriting.

33. The system of claim 21 further comprising an engine variable assigned to one or more of the questions in the comprehensive set of application questions for use in matching underwriting information previously obtained from the applicant to minimize redundant responses from the applicant.

34. The system of claim 33 wherein the server executing the processing rules determines if an external engine variable parameter received from the carrier matches any of the available responses to the questions for which the engine variable is assigned and, if so, presets the external engine variable parameter as the response to the questions.

40. The system of claim 39 wherein the presentation and controller layers reside on the web server and wherein the business logic and data mapping layers reside on the application server.
